(19) United States
(12) Patent Application Publication
(10) Pub. No.: US 2005/0141247 A1
(43) Pub. Date: Jun. 30, 2005

(54) Transformer with a plurality of coils in the secondary side

(76) Inventor: Pao Ching Huang, Taipei Hsien (TW)

Correspondence Address: Pao Ching Huang, 235 Chung-Ho, Box 8-24, Taipei, TW

(21) Appl. No.: 11/027,731

(22) Filed: Jan. 3, 2005

(30) Foreign Application Priority Data
Dec. 30, 2003 (CN) 200320131780.0

(51) Int. Cl. H02M 3/335

(52) U.S. Cl. 363/24

(57) ABSTRACT

A DC to AC inverter comprises: a DC input for inputting DC current; an inductor for filtering the high frequency components; a push pull transistor pair including a push-pull transistor pair. The collectors of the two transistors are connected to two ends of a capacitor set. A transformer has a primary side and a secondary side. The primary sides of the transformer and capacitor set are formed as an oscillating circuit so that so as to actuate the push-pull transistor pair alternatively for generating AC current. The secondary side of the transformer includes two second coils coupled to the primary side. One end of each of the second coils is grounded and the other end of the second coils is connected to a plurality of capacitors in parallel as output ends.

### FIELD OF THE INVENTION

The present invention relates to a transformer, and in particular to a transformer; wherein a secondary side of the transformer includes two coils. Each of the coils has one grounded end. The currents of the two grounded ends of the two coils are opposite. The two coils are coupled to the same coil or different coils of the primary side of the transformer. Each the two coils has a non-grounded end. The two non-grounded ends are connected to two ends of a load. A voltage difference of the two non-grounded ends is the sum of the voltage differences of the two coils.

### BACKGROUND OF THE INVENTION

With reference to FIG. 1, a prior art DC to AC inventor is illustrated. In this prior art, a DC input 1 serves for inputting DC current. An inductor L1 is used to filter the high frequency components to transfer to the DC input end 1. A push pull pair includes a transistor Q5 and a transistor Q6, where transistor Q5 is an NPN transistor and transistor Q6 is a PNP transistor. The base of the transistor Q5 is connected to the inductor L1 through a resistor R13 and the base of the transistor Q6 is connected to the inductor L1 through a resistor R12. The emitters of the two transistors are grounded. The collectors of the two transistors are connected to the two ends of a capacitor C14. Thereby, the two transistors are impossible to be “on” at the same time. That is to say that at a time, only one transistor turns on.

The prior art circuit further comprises a transformer PT1. A primary side of the transistor PT1 include three coils, Y11, Y12 and Y13. Each of the coils Y11 and Y12 has an end connected to the collectors of the transistor Q5 and transistor Q6 and the other ends of the coils Y11 and Y12 are connected to the DC inputs. The two ends of the coils Y13 are connected to the bases of two transistors Q5 and Q6. Thereby, the primary side sides of the transformer is formed as an oscillating circuit by the coils Y11-Y13 and the capacitor C14.

The positive cycle of the oscillating circuit will actuate the transistor Q5 and turn off the transistor Q6. Contrary, the negative cycle of the oscillating circuit will actuate the transistor Q6 and turn off the transistor Q5. Thereby, outputs of the push-pull circuit are AC current.

The secondary side of the transformer PT1 includes only one coil Y2. The coil ratios of the primary side to the secondary side are several tens to several hundreds. Thereby, the secondary sides of the transformer can output voltages of several hundreds to several thousands. One end of the coil Y2 is grounded and the other end is connected to one end of the capacitor C10 so as to filter out the DC components.

A load can be connected to the other end of the capacitor C10 and the ground so that the AC voltage from the secondary coil is applied to the load. For example, the load may be a cold cathode ray tube. Thereby, the voltage from the coil at the secondary side can be applied to the cold cathode ray tube so as to make the cold cathode ray tube to light up.

However above said prior art provides only one voltage which is too high to be damage the DC to AC inverter or the load installed at the secondary side of the transformer.

### SUMMARY OF THE INVENTION

Accordingly, the primary object of the present invention is to provide a transformer. A secondary side of the transformer includes two coils. Each of the coils has one grounded end. The currents of the two grounded ends of the two coils are opposite. The two coils are coupled to the same coil or different coils of the primary side of the transformer. Each the two coils has a non-grounded end. The two non-grounded ends are connected to two ends of a load. A voltage difference of the two non-grounded ends is the sum of the voltage differences of the two coils.

Furthermore, the present invention further provides a DC to AC inverter which comprises: a DC input for inputting DC current; an inductor for filtering the high frequency components; a push pull transistor pair including a first transistor and a second transistor, where the first transistor is an NPN transistor and the second transistor is a PNP transistor; the emitters of the two transistors are connected; the collectors of the two transistors being connected to two ends of a capacitor set; transformer having a primary side and a secondary side; the primary side of the transistor including three first coils; each of two selected first coils having an end connected to the collectors of the first and second transistors and the other ends of the first coils being connected to the DC inputs; the two ends of the other first coils being connected to the bases of two transistors; and the secondary side of the transformer includes two second coils coupled to the primary side.

The various objects and advantages of the present invention will be more readily understood from the following detailed description when read in conjunction with the appended drawing.

### BRIEF DESCRIPTION OF THE DRAWINGS

FIG. 1 shows the circuit diagram of the prior art DC to AC inverter.

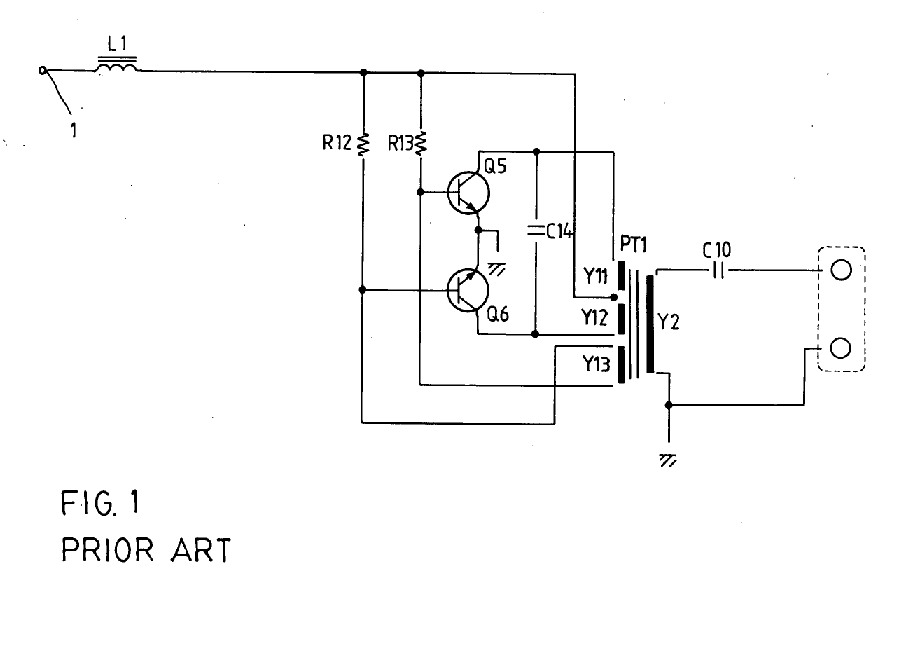

FIG. 2 shows the circuit diagram of a DC to AC inverter in the first embodiment of the present invention.

FIG. 3 shows the wave diagram in the first embodiment of the present invention, wherein voltages at two ends for connecting a load are measured.

FIG. 4 shows the circuit diagram of a DC to AC inverter in the second embodiment of the present invention.

### DETAILED DESCRIPTION OF THE PREFERRED EMBODIMENTS

In the following, the preferred embodiment of the present invention will be described with reference to the drawings. In all the specification, like elements are numerated by the same numbers.

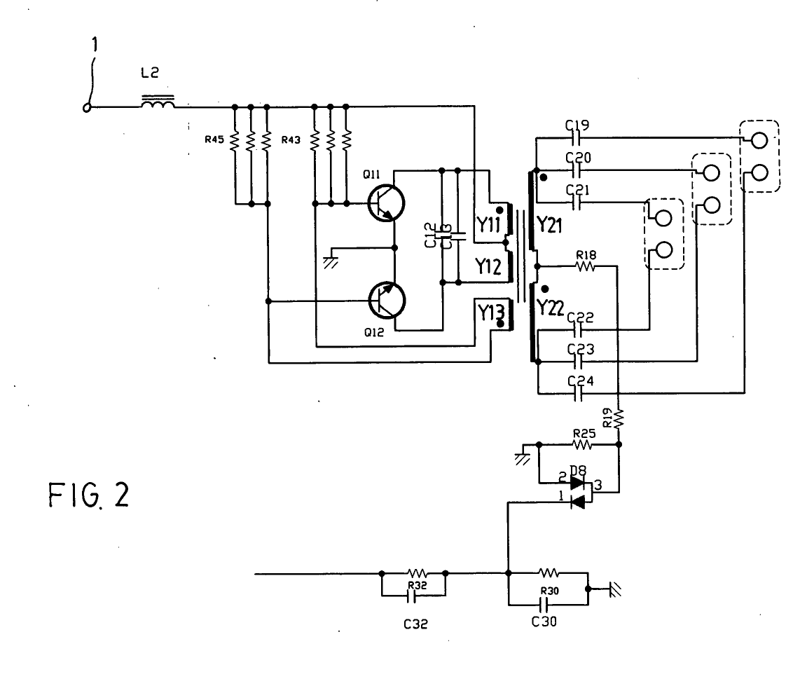

Referring to FIG. 2, the first preferred embodiment of the present invention will be described herein.

A DC input 1 serves for inputting DC current. An inductor L2 is used to filter the high frequency components to transfer to the DC input end 1. A push pull pair includes a transistor Q11 and a transistor Q12, where for example, the transistor Q11 may be an NPN transistor and the transistor Q12 may be a PNP transistor. The base of the transistor Q11 is connected to the inductor L2 through a resistor set R43 and the base of the transistor Q12 is connected to the inductor L2 through a resistor set R45. In this embodiment, each of the resistor sets R43 and R45 include three parallel connected resistors which are used to reduce the electric load so as to prevent from damage. The emitters of the two transistors are grounded. The collectors of the two transistors are connected to the two ends of two capacitor C12 and C13 which are connected in parallel. Thereby, the two transistors are impossible to be “on” at the same time. That is to say that at a time, only one transistor turns on.

The circuit further comprises a transformer T. A primary side of the transistor T include three coils, Y11, Y12 and Y13. Each of the coils Y11 and Y12 has an end connected to the collectors of the transistor Q11 and transistor Q12 and the other ends of the coils Y11 and Y12 are connected to the DC inputs. The two ends of the coils Y13 are connected to the bases of two transistors Q11 and Q12. Thereby, the primary side of the transformer is formed as an oscillating circuit by the coils Y11-Y13 and the capacitor C12.

The positive cycle of the oscillating circuit will actuate the transistor Q11 and turn off the transistor Q12. Contrary, the negative cycle of the oscillating circuit will actuate the transistor Q12 and turn off the transistor Q11. Thereby, outputs of the push-pull circuit are AC current.

The secondary side of the transformer includes two coils Y21 and Y22. The coil ratios of the primary side to the secondary side are several tens to several hundreds. Thereby, the secondary sides of the transformer can output voltages of several hundreds to several thousands. One end of each of the coils Y21 and Y22 is grounded and the other end is connected to one end of each of a plurality of capacitors C19, C20, C21 for coil Y21 and a plurality of capacitors C22, C23, C24 for coil Y22 so as to filter out the DC components. The other ends of the coils Y21 and Y22 are grounded. The other ends of the capacitors C19 and C22 are connected to a first load, the other ends of the capacitors C20 and C23 are connected to a second load, and the other ends of the capacitors C19 and C22 are connected to a third load. The loads may be for example, cold cathode ray tubes. Thereby, the voltage from the coil at the secondary side can be applied to the cold cathode ray tubes so as to make the cold cathode ray tubes light up.

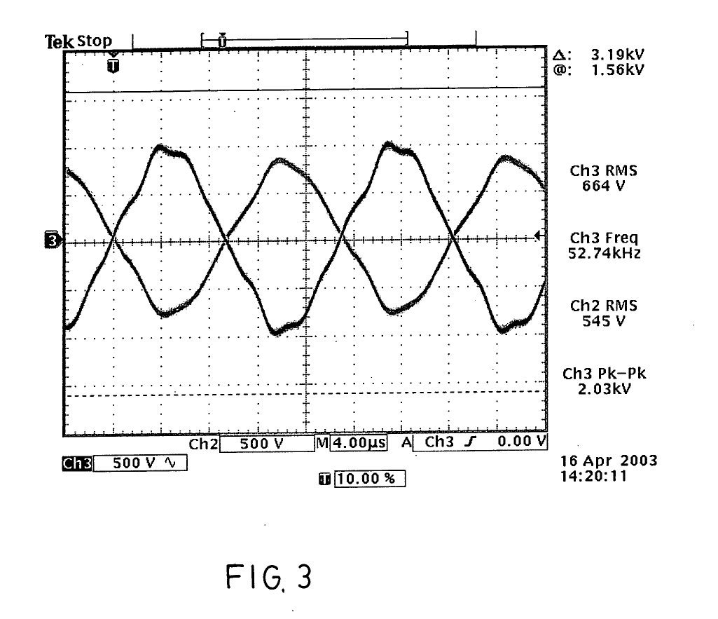

Referring to FIG. 3, FIG. 3 shows the wave diagram in the first embodiment of the present invention, wherein the voltages of two points between two sides of a load are measured by two channels, channel 2 and channel 3 and thus two voltage waves are shown in the drawings. The RMS (root mean square) voltages of the channels 2 and 3 are 545V and 664V. Moreover, the two voltage waves have opposite phases (that is, the phase differences of the two waves are 180 degrees. This is the exact result of push-pull transistor pair. Thus if the load is a cold cathode ray tube. The voltage difference at two sides of the cold cathode ray tube is the addition of the voltage wave with a peak value of 1209.

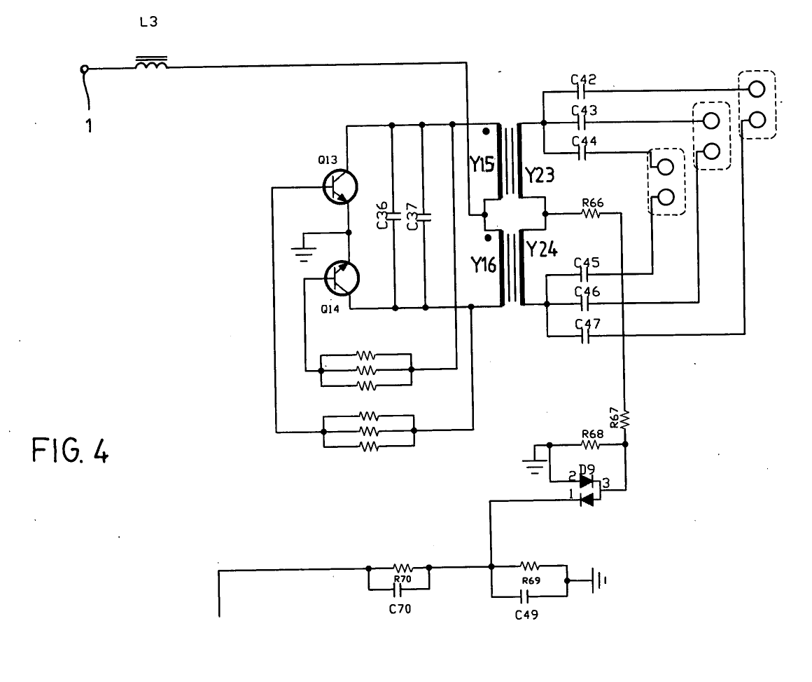

FIG. 4 shows the circuit diagram of a DC to AC inverter in the second embodiment of the present invention. A DC input 1 serves for inputting DC current. An inductor L3 is used to filter the high frequency components to transfer to the DC input end 1. A push pull pair includes a transistor Q13 and a transistor Q14, where transistor Q13 is an NPN transistor and transistor Q14 is a PNP transistor. The base of the transistor Q13 is connected to the collector of transistor Q14 through a resistor set R60 and the base of the transistor Q14 is connected to the collector of the transistor Q13 through a resistor set R63. In this embodiment, each of the resistor sets R63 and R60 include three parallel connected resistors which are used to reduce the electric load so as to prevent from damage. The emitters of the two transistors are grounded. The collectors of the two transistors are connected to the two ends of two capacitor C36 and C37 which are connected in parallel. Thereby, the two transistors are impossible to be “on” at the same time. That is to say that at a time, only one transistor turns on.

The circuit further comprises a transformer T. A primary side of the transistor T include two coils, Y15, and Y16. Each of the coils Y15 and Y16 has an end connected to the collectors of the transistor Q13 and transistor Q14 and the other ends of the coils Y15 and Y16 are connected to the DC inputs. One end of the coil Y15 is connected to the collector of the transistor Q13, and the other end thereof is connected to the inductor L3. One end of the coil Y16 is connected to the collector of the transistor Q14, and the other end thereof is connected to the inductor L3.

The positive cycle of the oscillating circuit will actuate the transistor Q13 and turn off the transistor Q14. Contrary, the negative cycle of the oscillating circuit will actuate the transistor Q14 and turn off the transistor Q13. Thereby, outputs of the push-pull circuit are AC current.

The secondary side of the transformer includes two coils Y23 and Y24. The coil ratios of the primary side to the secondary side are several tens to several hundreds. Thereby, the secondary sides of the transformer can output voltages of several hundredth to several thousandth. One end of each of the coils Y23 and Y24 is grounded and the other end is connected to one end of each of a plurality of capacitors C42, C43, C44 for coil Y23 and a plurality of capacitors C45, C46, C47 for coil Y24 so as to filter out the DC components. The other ends of the coils Y23 and Y24 are grounded. The other ends of the capacitors C42 and C45 are connected to a first load, the other ends of the capacitors C43 and C46 are connected to a second load, and the other ends of the capacitors C44 and C47 are connected to a third load. The loads may be for example, cold cathode ray tubes. Thereby, the voltage from the coil at the secondary side can be applied to the cold cathode ray tubes so as to make the cold cathode ray tubes light up.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A transformer; a secondary side of the transformer including two coils; each of the coils having one grounded end; the currents of the two grounded ends of the two coils being opposite; the two coils being coupled to the same primary side of the transformer; each the two coils having a non-grounded end; the two non-grounded ends being connected to two ends of a load; a voltage difference of the two non-grounded ends being the sum of the voltage differences of the two coils.

2. The transformer as claimed in claim 1, wherein the numbers of the windings of the two coils of the secondary side are equal so that the two coils have same voltage difference.

3. The transformer as claimed in claim 1, wherein each of the coil of the secondary side is wounded around a wire frame having a plurality of slots.

4. The transformer as claimed in claim 1, wherein the load is a light source.

5. The transformer as claimed in claim 4, wherein the light source is one of a florescent light source, a large size display panel, an advertise lamp, and an LCE monitor.

6. A transformer; a secondary side of the transformer including two coils; each of the coils having one grounded end; the currents of the two grounded ends of the two coils being opposite; the two coils being coupled to different coils of the primary side of the transformer; each the two coils having a non-grounded end; the two non-grounded ends being connected to two ends of a load; a voltage difference of the two non-grounded ends being the sum of the voltage differences of the two coils.

7. The transformer as claimed in claim 6, wherein the numbers of the windings of the two coils of the secondary side are equal so that the two coils have same voltage difference.

8. The transformer as claimed in claim 6, wherein each of the coil of the secondary side is wounded around a wire frame having a plurality of slots.

9. The transformer as claimed in claim 6, wherein the load is a light source.

10. The transformer as claimed in claim 9, wherein the light source is one of a florescent light source, a large size display panel, an advertise lamp, and an LCE monitor.

11. A DC to AC inverter comprising:
a DC input for inputting DC current;
an inductor for filtering the high frequency components;
a push pull transistor pair including a first transistor and a second transistor, wherein the first transistor is an NPN transistor and the second transistor is a PNP transistor; the emitters of the two transistors are connected together;
a capacitor set; the collectors of the two transistors being connected to two ends of a capacitor set;
a transformer having a primary side and a secondary side;
the primary side of the transistor including three first coils; each of two selected first coils having an end connected to the collectors of the first and second transistors and the other ends of the first coils being connected to the DC inputs; the two ends of the other first coils being connected to the bases of two transistors; and
the secondary side of the transformer including two second coils coupled to the primary side; one end of each of the second coils being grounded and the other end of the second coils being connected to a plurality of capacitors in parallel as output ends.

12. The DC to AC inverter as claimed in claim 11, wherein two output ends from different second coils are connected to two ends of a load.

13. The DC to AC inverter as claimed in claim 11, wherein the capacitor set has a plurality of parallel connected capacitors.

14. The DC to AC inverter as claimed in claim 11, wherein each base of the two transistors is connected to a resistor, and then the resistor is connected to the inductor.
